(19) United States
(12) Patent Application Publication
(10) Pub. No.: US 2013/0003370 A1
(43) Pub. Date: Jan. 3, 2013

(54) Lighting Device And Lighting Apparatus Provided With Lighting Device

(75) Inventor: Yukio Watanabe, Osaka (JP)

(73) Assignee: Sharp Kabushiki Kaisha, Osaka (JP)

(21) Appl. No.: 13/514,564

(22) PCT Filed: Jun. 8, 2010
(86) PCT No.: PCT/JP2010/059722

§ 371 Date: Jun. 7, 2012

(30) Foreign Application Priority Data
Feb. 5, 2010 (JP) 2010-024758

(51) Int. Cl. F21V 5/02; F21V 5/04

(52) U.S. Cl. 362/244

(57) ABSTRACT

A lighting device (10) includes an optical member (1) having (i) an entrance surface which is provided with a columnar convex lens and a prism group constituted by a plurality of prisms and (ii) an exit surface (1 a) which is provided with a prism group (4a, 4b) constituted by a plurality of prisms that differ in shape. The prism group (4a) which is provided on the exit surface (1 a) changes a direction of a light ray which (i) is emitted in a normal direction of a substrate surface by being reflected therein and (ii) has a high intensity to a direction which is highly inclined with respect to the normal direction. Accordingly, it is possible to provide the lighting device (10) which has a simple arrangement and is capable of controlling a light distribution characteristic.

### TECHNICAL FIELD

The present invention relates to a lighting device and a lighting apparatus each of which has a simple arrangement and is capable of controlling a light distribution characteristic, particularly to lighting apparatuses such as a road light, an outdoor security light, and a street light each of which has a high illuminance and a wide light distribution characteristic, and a lighting device which is suitable for such a lighting apparatus.

### BACKGROUND ART

Many lighting apparatuses are provided outdoors for traffic safety, crime prevention, and the like.

For example, in order to allow a driver to understand a road state without fail and not to cause light from a lighting apparatus to prevent visibility during driving, evaluation values for an average brightness of an illuminated road, a uniformity ratio of brightness, and a glare are specified for a road light.

Commonly, road lights are set at a height of 7 m to 10 m and at regular intervals of approximately 30 m to 40 m in many cases. A road light is required to have a light distribution characteristic of having a peak in a vicinity of ±65° from a lighting apparatus and cutting light at ±70° or more from the lighting apparatus. In order to obtain such a light distribution characteristic and to meet a higher standard for a specified value required for a road light, it is necessary to precisely control light distribution of the lighting apparatus.

A technique for controlling a light distribution characteristic of a lighting apparatus is exemplified by a method described in Patent Literature 1. A lighting apparatus described in Patent Literature 1 causes a reflecting member (light controller) called a reflector to control a light distribution characteristic, so as to increase a luminous intensity in a horizontal direction.

Patent Literature 2 describes a lighting apparatus including a plurality of light source bodies each of which is constituted by a light source and a shell reflector. The lighting apparatus of Patent Literature 2 in which a reflector is provided for each light source causes the lighting apparatus to be less likely to be larger.

Patent Literature 3 describes a lighting apparatus which causes a concave lens to control a light distribution characteristic.

### CITATION LIST

### Patent Literatures

### Patent Literature 1

Japanese Patent Application Publication, Tokukaihei, No. 5-198205 A (Publication Date: Aug. 6, 1993)

### Patent Literature 2

Japanese Patent Application Publication, Tokukai, No. 2009-152169 A (Publication Date: Jul. 9, 2009)

### Patent Literature 3

Japanese Patent Application Publication, Tokukai, No. 2009-252375 A (Publication Date: Oct. 29, 2009)

### SUMMARY OF INVENTION

### Technical Problem

However, a conventional lighting apparatus described above has the following problem.

Many lighting apparatuses have recently been developed which use LED light sources from the viewpoint of electric power saving and longevity. According to a lighting apparatus using LED light sources, many LED light sources are provided to secure an installed flux in many cases. This increases a light source area.

In this case, if light distribution is to be controlled by use of a reflector as in the case of the lighting apparatus described in Patent Literature 1, light enters the reflector from various directions. This causes a problem such that it is difficult to set a shape of the reflector. In a case where a light source area is reduced in ratio by increasing an area of the reflector and/or a prism so as to avoid the problem, there occurs a problem such that the lighting apparatus becomes larger.

The lighting apparatus which is described in Patent Literature 2 and in which a reflector is provided for each light source causes the lighting apparatus to be less likely to be larger. However, this causes an increase in number of parts.

The lighting apparatus described in Patent Literature 3 allows a concave lens to widen an angle of a light ray at an outer edge of a light source. However, the concave lens cannot widen an angle of a light ray in a central region of the light source. Accordingly, the lighting apparatus described in Patent Literature 3 insufficiently controls a light distribution characteristic.

It is important for a lighting apparatus which is set for a road and the like to control light distribution in two planes which are parallel to a road traffic direction and a road width direction, respectively. However, this complicates a method for providing a light source body and causes an increase in production cost.

The present invention has been made in view of the conventional problems, and an object of the present invention is to provide a lighting device and a lighting apparatus each of which has a simple arrangement and is capable of controlling a light distribution characteristic.

### Solution to Problem

In order to attain the object, a lighting device of the present invention includes: a plurality of light sources; and an optical member having an entrance surface and an exit surface with respect to light emitted from the respective plurality of light sources, the exit surface being provided with a first prism group which is constituted by a plurality of prisms, and the first prism group widening, in a direction which is orthogonal to a longer side direction thereof, an angle of distribution of light rays emitted from the plurality of light sources.

According to the arrangement, the first prism group is provided on the exit surface of the optical member. According to this, the light rays having entered the first prism group from the plurality of light sources dramatically change in direction by being reflected by the first prism group. Specifically, the light rays are diffused in the direction which is orthogonal to the longer side direction of the first prism group. This allows the first prism group to change a direction of the light rays which are emitted from the plurality of light sources and have a high intensity to a direction which is inclined with respect to a normal direction of a surface on which the plurality of light sources are provided. Accordingly, a lighting apparatus in which an angle of light distribution is further widened can be made.

Further, according to the arrangement, only one optical member with respect to a plurality of light sources can widen an angle of distribution of light rays emitted from the plurality of light sources. That is, it is possible to control a light distribution characteristic without the need of providing reflectors as described in Patent Literatures 1 and 2.

Accordingly, it is possible to make a lighting device which has a simple arrangement and is capable of controlling a light distribution characteristic.

Note that the arrangement allows only the optical member to control a light distribution characteristic without the need of providing a reflector. This (i) allows the lighting device to be thinner and smaller and (ii) allows the lighting device to be easy to assemble and highly efficient. Further, the lighting device which is thinner and smaller makes it possible to provide a well-designed lighting device. In addition, since it is unnecessary to provide a reflector, a reduction in number of parts allows a cost reduction.

### Advantageous Effects of Invention

As described earlier, each of a lighting device and a lighting apparatus of the present invention includes: a plurality of light sources; and an optical member having an entrance surface and an exit surface with respect to light emitted from the respective plurality of light sources, the exit surface being provided with a first prism group which is constituted by a plurality of prisms, and the first prism group widening, in a direction which is orthogonal to a longer side direction thereof, an angle of distribution of light rays emitted from the plurality of light sources. The arrangement yields an effect of providing a lighting device and a lighting apparatus each of which has a simple arrangement and is capable of controlling a light distribution characteristic.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 illustrates a lighting device of an embodiment of the present invention. (a) of FIG. 1 a perspective view illustrating an appearance of the lighting device. (b) of FIG. 1 is a plan view of a substrate which is provided in the lighting device. (c) of FIG. 1 is a plan view of an exit surface of an optical member which is provided in the lighting device. (d) of FIG. 1 is a plan view of an entrance surface of the optical member.

FIG. 2

FIG. 2 has cross-sectional views of the lighting device of

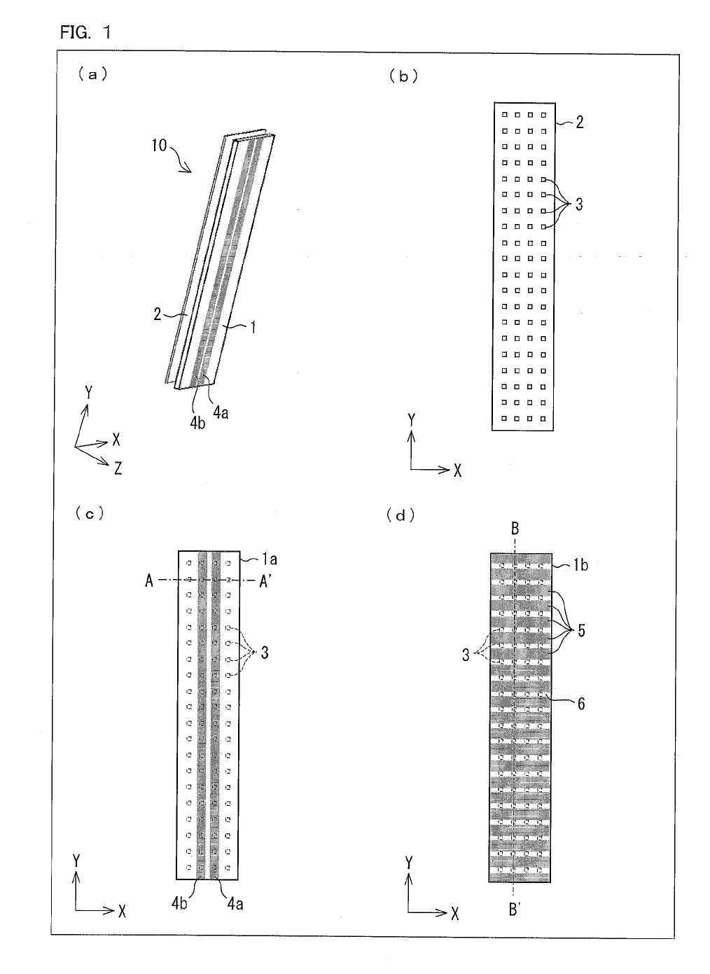

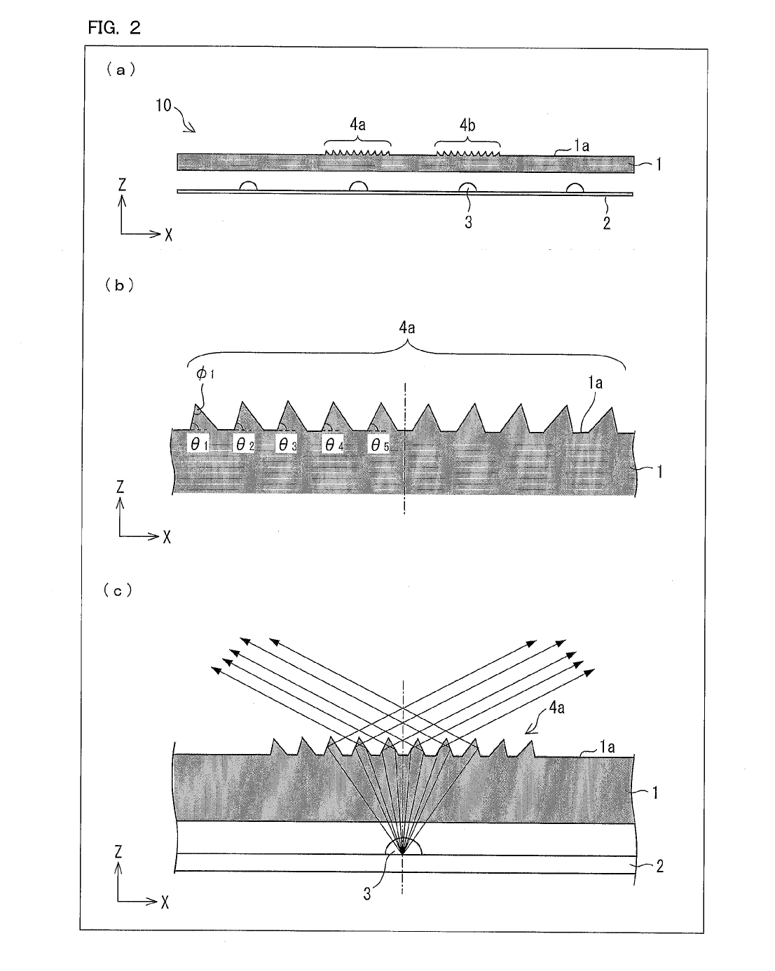

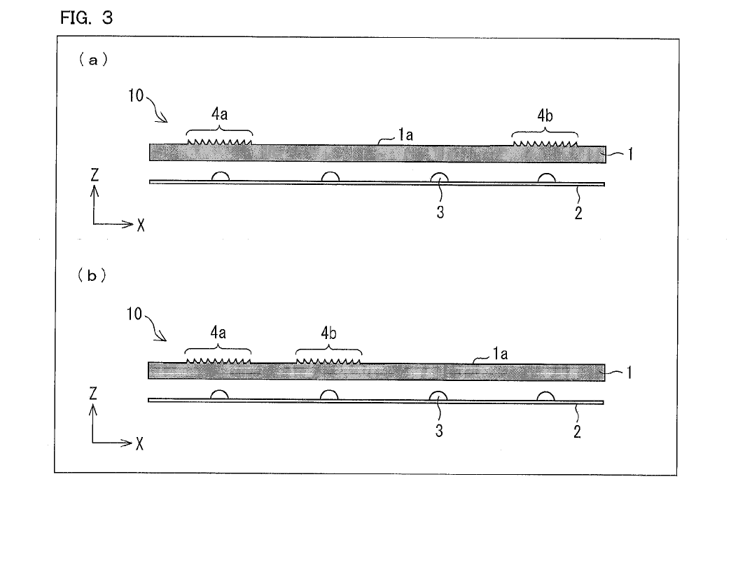

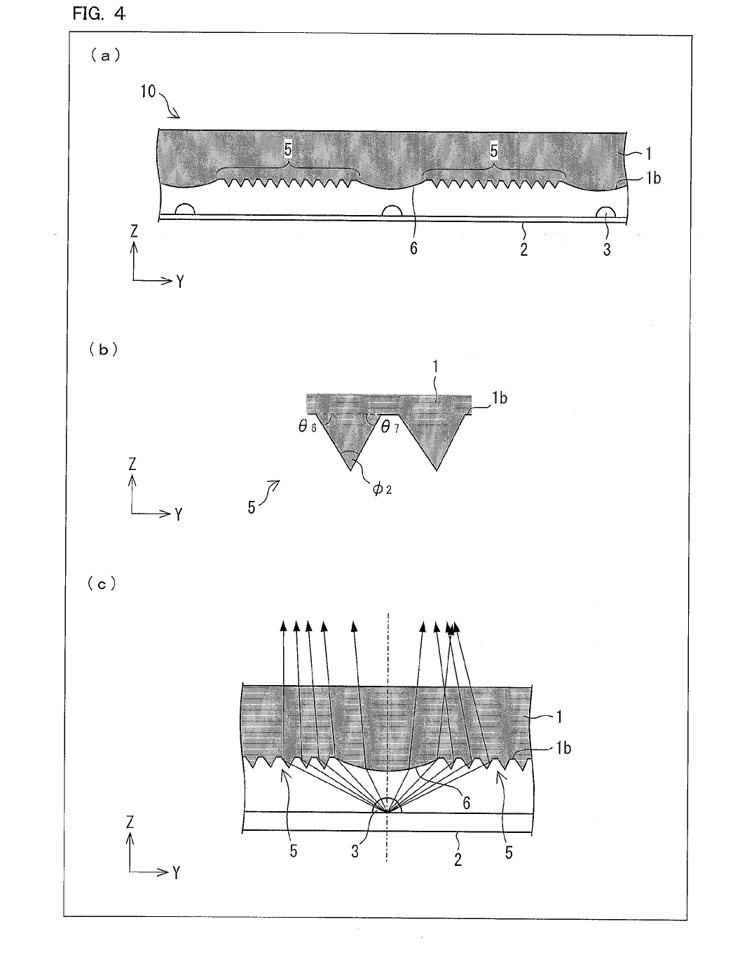

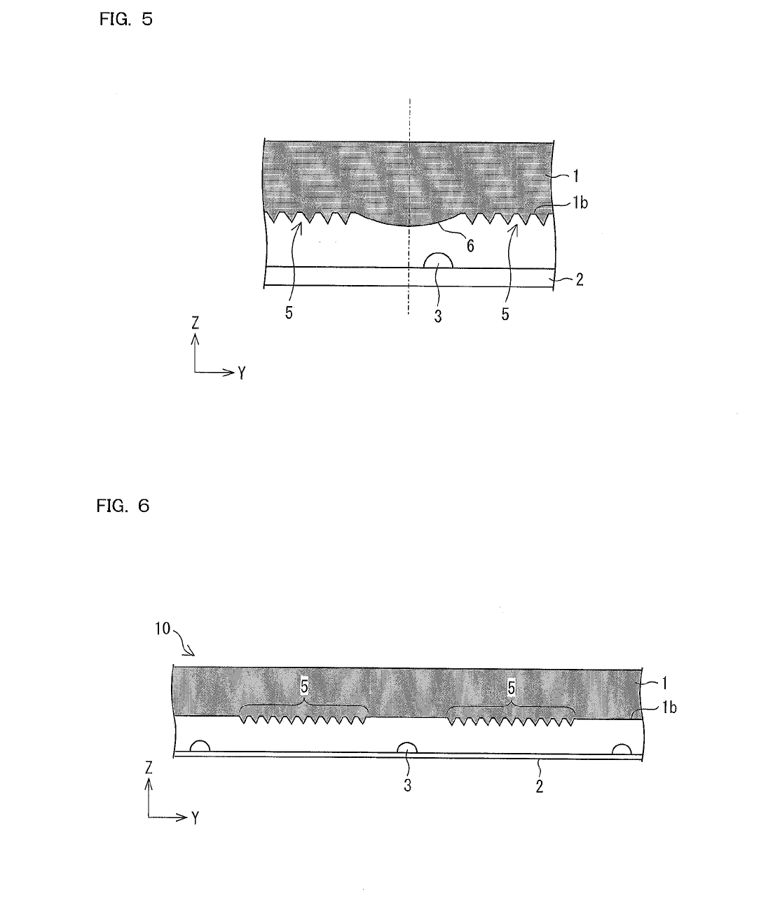

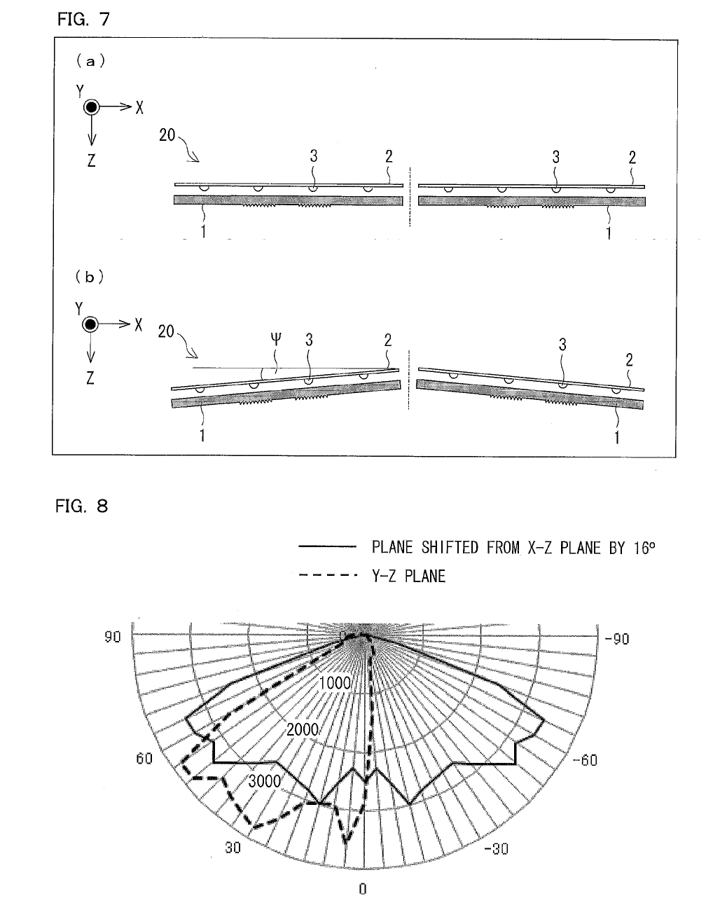

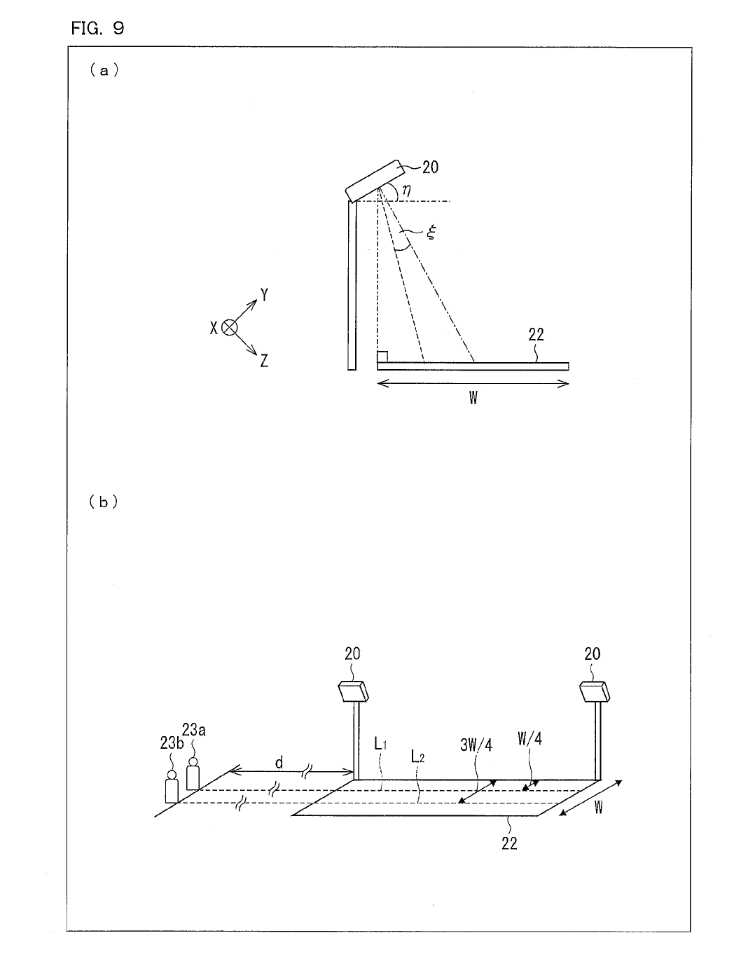

FIG. 1. (a) of FIG. 2 is the cross-sectional view taken from line A-A′ of (c) of FIG. 1. (b) of FIG. 2 is an enlarged view of a structure of a prism group provided on the exit surface of the optical member of (a) of FIG. 2. (c) of FIG. 2 illustrates paths of respective light rays via the optical member of (a) of FIG. 2.

FIG. 3

FIG. 3 has cross-sectional views of the lighting device of the present invention. Each of (a) and (b) of FIG. 3 illustrates a structure of another prism group provided on the exit surface of the optical member.

FIG. 4

FIG. 4 has cross-sectional views of the lighting device of FIG. 1. (a) of FIG. 4 is the cross-sectional view taken from line B-B′ of (d) of FIG. 1. (b) of FIG. 4 is an enlarged view of a structure of a prism group provided on the entrance surface of the optical member of (a) of FIG. 4. (c) of FIG. 4 illustrates paths of respective light rays via the optical member of (a) of FIG. 4.

FIG. 5

FIG. 5 illustrates another structure provided on the entrance surface of the optical member of the lighting device of the present invention.

FIG. 6

FIG. 6 illustrates another structure provided on the entrance surface of the optical member of the lighting device of the present invention.

FIG. 7

Each of (a) and (b) of FIG. 7 schematically illustrates a lighting apparatus including the lighting device.

FIG. 8

FIG. 8 shows a result of simulation of a light distribution characteristic of the lighting apparatus of (a) of FIG. 7.

FIG. 9

FIG. 9 illustrates an evaluation condition in a case where the lighting apparatus of (a) of FIG. 7 is used as a road light. (a) of FIG. 9 illustrates a state in which the lighting apparatus is provided. (b) of FIG. 9 shows a relationship between the lighting apparatus and an observer.

### DESCRIPTION OF EMBODIMENTS

The present invention is more specifically described below with reference to the following embodiment. Note that members having identical functions and effects are given respective identical reference numerals, and a description of those members is omitted in the following description.

FIG. 1 illustrates a lighting device 10 of the present embodiment. (a) of FIG. 1 a perspective view illustrating an appearance of the lighting device 10. (b) of FIG. 1 is a plan view of a substrate 2 which is provided in the lighting device 10. (c) of FIG. 1 is a plan view of an exit surface 1a of an optical member 1 which is provided in the lighting device 10. (d) of FIG. 1 is a plan view of an entrance surface 1b of the optical member 1.

The lighting device 10 of the present embodiment includes the optical member 1 and the substrate 2 (see (a) of FIG. 1). Note here that an axis direction in which light is inputted/outputted is a z-axis, a longer side direction of the lighting device 10 is a y-axis, and a shorter side direction is an x-axis.

A plurality of light sources 3 are provided in a matrix pattern on the substrate 2 (see (b) of FIG. 1). The present embodiment takes, as an example, an arrangement in which 80 light sources 3 in total are provided such that four light sources 3 per row are provided in an x direction in parallel and 20 light sources 3 per column are provided in a y direction in parallel.

Not only an LED but also a light source such as a semiconductor laser is usable as a light source 3.

Prism shapes and columnar convex lens shapes are provided on a top surface of the optical member 1. Namely, prism groups 4a and 4b (first prism groups) each of which is constituted by a plurality of prisms are provided on the exit surface 1a of the optical member 1 (see (c) of FIG. 1). Meanwhile, prism groups 5 (second prism groups) each of which is constituted by a plurality of prisms and columnar convex lenses 6 are provided on the entrance surface lb of the optical member 1 (see (d) of FIG. 1).

Specifically, (c) of FIG. 1 shows a positional relationship between (i) a region in which the prism groups 4a and 4b provided on the light exit side of the optical member 1 are provided and (ii) the plurality of light sources 3 provided on the substrate 2. The prism groups 4a and 4b are provided in a gray-colored region in (c) of FIG. 1. The prism groups 4a and 4b are provided directly above the light sources 3 in respective central two columns. Namely, the prism groups 4a and 4b are provided on the exit surface 1a in a longer side direction of the light sources 3 in the central two columns. The prism groups 4a and 4b, each of which includes a plurality of prisms, are provided so as to be spaced from each other.

Meanwhile, (d) of FIG. 1 shows a positional relationship between (i) a region in which the prism groups 5 and the columnar convex lenses 6 each of which is provided on the light entrance side of the optical member 1 are provided and (ii) the plurality of light sources 3 provided on the substrate 2. The prism groups 5 are provided in a gray-colored region in (d) of FIG. 1. The prism groups 5 are provided so as to be spaced from each other at regular intervals in a shorter side direction of the entrance surface 1b. Each of the prism groups 5 is constituted by a plurality of prisms. The columnar convex lenses 6 are provided between the prism groups 5, i.e., in a white-colored region in (d) of FIG. 1. The prism groups 5 and the columnar convex lenses 6 are arranged such that the prism groups 5 are provided so as not to overlap the light sources 3 and the columnar convex lenses 6 are provided directly above the light sources 3. That is, the prism groups 5 and the columnar convex lenses 6 are periodically provided in a longer side direction of the prism groups 4a and 4b. According to the present embodiment, the prism groups 5 and the columnar convex lenses 6 are alternately provided in the longer side direction of the prism groups 4a and 4b. The prism groups 5 and the columnar convex lenses 6 constitute lens sections (optical path converting sections) for converting an optical path of light which enters the optical member 1.

Next, the following description discusses, with reference to FIG. 2, a shape of the exit surface 1a of the optical member 1 of the lighting device 10. FIG. 2 has cross-sectional views of the lighting device 10 of FIG. 1. (a) of FIG. 2 is the cross-sectional view taken from line A-A′ of (c) of FIG. 1. (b) of FIG. 2 is an enlarged view of a structure of the prism group 4a provided on the exit surface 1a of the optical member 1 of (a) of FIG. 2. (c) of FIG. 2 illustrates paths of respective light rays via the optical member 1 of (a) of FIG. 2. Note that, though only the prism group 4a is illustrated in each of (b) and (c) of FIG. 2, same applies to the prism group 4b.

The present embodiment takes, as an example, an arrangement such that each of the prism groups 4a and 4b is constituted by 10 prisms (see (a) of FIG. 2). The longer side direction of the prism groups 4a and 4b is set as a y-axis direction of the lighting device 10. A center of each of the prism groups 4a and 4b is set so as to be directly above a center of a corresponding light source 3.

The prism group 4a has a shape which is symmetrical with respect to an axis passing through the center of the light source 3 and the center of the prism group 4a (see (b) of FIG. 2). Further, the prisms constituting the prism group 4a are set to have respective different ones (θ1, θ2, . . . θ5) of base angles (inclination angles). In this example, the prisms are set to gradually decrease in one (θ1, θ2, . . . θ5) of base angles as the prisms are closer to a central axis of the prism group 4a (from the left end in (b) of FIG. 2), the one of the base angles being farther from the central axis than the other of the base angles. All the prisms are set to be identical in vertex angle φ1.

(c) of FIG. 2 illustrates rays of light which is emitted from the light source 3 and passes through the optical member 1 via the prism group 4a. The light emitted from the light source 3 enters the optical member 1 and then reaches the prism group 4a provided on the exit surface 1a. Each of the prisms has a prism plane whose angle is set so that a part or all of light rays having reached the prism plane are totally reflected. Therefore, in a case where a light ray having entered the prism plane of the prism group 4a is totally reflected in the prism plane, the light ray dramatically changes in direction. Namely, in a case where a light source which has a high luminous intensity in a directly upper direction is used as the light source 3, a distribution direction of light having a high luminous intensity dramatically changes with respect to the z-axis. That is, the prism group 4a causes light rays emitted from the light source 3 to be diffused, so that an angle of distribution of the light rays thus diffused is widened. This allows obtainment of a light distribution characteristic such that a region directly above the light source 3 is relatively low in luminous intensity.

The prism group 4a thus widens, in a direction which is orthogonal to the longer side direction thereof, an angle of distribution of light rays emitted from the light sources 3.

Meanwhile, though light rays emitted from the light sources 3 directly above which no prism group 4a is provided and which belong to outer two columns are affected by (i) Fresnel reflection by the entrance surface 1b and the exit surface 1a of the optical member 1 and (ii) total reflection inside the optical member 1, distribution of the light rays in an x-z plane is not subjected to a great change. Therefore, a light distribution characteristic of the light sources 3 is reflected as it is, so that a light distribution characteristic is obtained such that light from the outer two columns has a relatively high luminous intensity in a region directly above the light sources 3.

As described earlier, a desired light distribution characteristic can be obtained by combining a part in which the prism groups 4a and 4b are provided directly above the light sources 3 and a part in which no prism groups 4a and 4b are provided directly above the light sources 3. Light distribution can be precisely controlled by changing the base angles θ1, θ2, . . . θ5 of the respective prisms. In the case of the example of FIG. 2, as light rays reach respective prism planes at larger entrance angles, the base angles θ1, θ2, . . . θ5 of the respective prisms change to be larger. Accordingly, a characteristic is obtained such that exit light is distributed in a uniform direction.

In a case where each of the prism groups 4a and 4b has a simple shape, the optical member 1 can be easily prepared, and the lighting device 10 which is less likely to change in lighting characteristic can be made even if the optical member 1 and the light sources 3 are positionally displaced.

Note that, according to the example illustrated in FIG. 2, in view of easiness of preparation of the optical member 1 and a tolerance, each of the prism groups 4a and 4b (i) has prism shapes which are identical in vertex angle (φ1) and (ii) has a shape which is symmetrical with respect to a central axis thereof. However, a shape of each of the prism groups 4a and 4b is not limited to such a shape. Alternatively, each of the prism groups 4a and 4b may be constituted by prisms which differ in vertex angle or may have a shape which is asymmetrical with respect to the central axis.

The prism groups 4a and 4b are provided directly above the light sources 3 in the respective central two columns (see (b) of FIG. 1 and (a) of FIG. 2). However, a part in which the prism groups 4a and 4b are provided is not limited to this. Namely, as illustrated in FIG. 3, the prism groups 4a and 4b do not need to be provided in the respective central two columns. FIG. 3 has cross-sectional views of the lighting device 10. Each of (a) and (b) of FIG. 3 illustrates structures of respective other prism groups 4a and 4b provided on the exit surface 1a of the optical member 1. The prism groups 4a and 4b may be provided directly above the light sources 3 in the respective outer two columns (see (a) of FIG. 3). Alternatively, the prism groups 4a and 4b may be provided directly above the light sources 3 in respective left two columns (see (b) of FIG. 3).

As described earlier, according to the lighting device 10 of the present embodiment, a direction of light rays which (i) are supposed to be emitted in a normal direction of a surface of the substrate 2 on which surface the plurality of light sources 3 are provided and (ii) have a high intensity can be easily changed to a direction which is highly inclined with respect to the normal direction. Accordingly, the lighting device 10 having a wide light distribution characteristic can be made. It is difficult to control a light distribution characteristic particularly of a road light by directing a lighting device outward from the viewpoint of prevention of a glare. Therefore, control of light distribution by the lighting device 10 of the present embodiment is effective in a road light (lighting apparatus) including the lighting device 10. Light distribution control of fine texture is necessary for meeting a required specification as a road light at a high standard. According to the lighting device 10, light distribution can be finely controlled by combining (i) a part in which the prism groups 4a and 4b are provided directly above the light sources 3 and (ii) a part in which no prism groups 4a and 4b are provided directly above the light sources 3. Accordingly, a road light including the lighting device 10 can meet the required specification as a road light at a high standard.

Next, the following description discusses, with reference to FIG. 4, a shape of the entrance surface 1b of the lighting device 10. FIG. 4 has cross-sectional views of the lighting device 10 of FIG. 1. (a) of FIG. 4 is the cross-sectional view taken from line B-B′ of (d) of FIG. 1. (b) of FIG. 4 is an enlarged view of a structure of a prism group 5 provided on the entrance surface 1b of the optical member 1 of (a) of FIG. 4. (c) of FIG. 4 illustrates paths of respective light rays via the optical member 1 of (a) of FIG. 4.

The prism groups 5 and the columnar lenses 6 are provided on the entrance surface 1b of the optical member 1 (see (a) of FIG. 4). The prism groups 5 and the columnar convex lenses 6 are provided in a shorter side direction of the optical member 1 (see (d) of FIG. 1). Namely, a longer side direction of the prism groups 5 and the columnar convex lenses 6 is an x direction. (a) of FIG. 4 shows, as an example, a case where the prism group 5 is constituted by 11 prisms. The columnar convex lenses 6 and the prism groups 5 are alternately provided in a longer side direction of the optical member 1. According to the example of (a) of FIG. 4, a center of a light source 3 is located on an optical axis of a corresponding columnar convex lens 6.

(b) of FIG. 4 is an enlarged view of a prism constituting the prism group 5. The prism group 5 is constituted by prisms which are provided at regular intervals and are identical in shape. Base angles θ6 and θ7 of the prism are different from each other and are in a relationship of θ6<θ7.

(c) of FIG. 4 illustrates light rays on the cross section taken from line B-B′ of (c) of FIG. 1. Light rays in a vicinity of a region directly above the light source 3 from which the light rays are emitted at a small emission angle and a large emission angle, respectively, enter the columnar convex lens 6 and the prism group 5, respectively. The light ray having entered the columnar convex lens 6 changes in optical path more inwardly in accordance with a curvature of the columnar convex lens 6 than that having entered a planar surface. Meanwhile, each of the prisms has a prism plane whose angle is set so that a part or all of light rays having reached the prism plane are totally reflected. Therefore, a light ray having entered the prism plane of the prism group 5 dramatically changes in direction by being totally reflected in the prism plane. In the case of FIG. 4, the prism group 5 is constituted by prisms each of which has a shape that is asymmetrical with respect to a straight line passing through a vertex of each of the prisms and being parallel to the z axis. Therefore, the entire direction of light rays to be subjected to distribution by the prism group 5 is inclined toward a z-axis direction.

A light ray emitted at a large emission angle is highly likely to be lost by being reflected in the top surface of the optical member 1 or being totally reflected inside the optical member 1. However, in a case where a direction of a light ray to exit from the optical member 1 is changed to a direction along the z-axis (see (c) of FIG. 4), a larger amount of light can be extracted from the optical member 1, so that a light utilization efficiency can be enhanced.

The prism groups 5 and the columnar convex lenses 6 thus narrow, in a direction in which the prism groups 5 and the columnar convex lenses 6 are periodically provided, an angle of distribution of light rays emitted from the light sources 3.

The lighting device 10 which efficiently illuminates a desired region can be made by a light collecting function of the columnar convex lenses 6 and the prism groups 5.

Distribution of light passing through the prism groups 5 and distribution of light passing through the columnar convex lenses 6 can be controlled separately to some extent. This allows an illuminance distribution to be designed more freely and facilitates obtainment of a desired illuminance distribution.

When seen in a y-z plane, the columnar convex lenses 6 are provided on the optical member 1 so as to correspond to the respective light sources 3. A prism group 5 is constituted by a plurality of prisms. This allows a lens height of a columnar convex lens 6 and a size of a prism to be substantially equivalent to a size of a light source 3. This allows a lighting apparatus to be thinner and smaller.

In order to prevent the optical member 1 from deteriorating due to generation of heat by the light source 3, it may be necessary to cause the optical member 1 and the light source 3 to be spaced from each other. In this case, in order to cause only the columnar convex lens 6 to enhance a light utilization efficiency, it is necessary to cause the columnar convex lens 6 to have a larger size (lens height) so as to collect light rays emitted at large emission angles. However, in a case where the prism group 5 has such a light collecting function, a problem of the need to increase a lens size can be solved. Accordingly, the optical member 1 can be prevented from deteriorating while remaining thin.

Note that a shape of the entrance surface 1b of the optical member 1 is not limited to the shape of FIG. 4. Each of FIGS. 5 and 6 illustrates another structure provided on the entrance surface lb of the optical member 1 of the lighting device 10. A center of the light source 3 does not need to coincide with a central axis (dashed line in FIG. 5) of the columnar convex lens 6 (see FIG. 5). As described above, a light distribution characteristic in the y-z plane can be controlled also by preventing an optical axis of the columnar convex lens 6 and an optical axis of the light source 3 from coinciding with each other.

Alternatively, the entrance surface of the optical member 1 may be arranged to be provided with only the prism groups 5 (see FIG. 6). The arrangement as illustrated in FIG. 6 is effective in a case where a light collecting effect is less necessary and a light utilization efficiency is desired to be increased. Further, the arrangement as illustrated in FIG. 6 allows the optical member 1 to be prepared easily.

It is only necessary that the optical member 1 be made of acrylic resin, polystyrene resin, methacrylic resin, polycarbonate resin, glass, or the like which is excellent in transparency in a visible light region and has a high transmissivity.

As described earlier, the lighting device 10 causes the columnar convex lenses 6, the prism groups 4a and 4b, and the prism groups 5 of the optical member 1 to control distribution of light emitted from the respective light sources 3. Namely, the columnar convex lenses 6 and the prism groups 5 each of which is provided on the entrance surface 1b of the optical member 1 have a function of narrowing light (narrowing an angle), whereas the prism groups 4a and 4b provided on the exit surface 1a of the optical member 1 have a function of widening light (widening an angle).

A generating line direction of the columnar convex lenses 6 and the prism groups 5 each of which is provided on the entrance surface 1b and a generating line direction of the prism groups 4a and 4b provided on the exit surface 1a are orthogonal to each other. That is, the longer side direction of the columnar convex lenses 6 and the prism groups 5 and the longer side direction of the prism groups 4a and 4b are orthogonal to each other. This allows only the optical member 1 to separately control light distribution characteristics in respective two planes of the x-z plane and the y-z plane.

Next, the following description discusses a lighting apparatus using the lighting device 10. Each of (a) and (b) of FIG. 7 schematically illustrates a lighting apparatus 20 including the lighting device 10. The lighting apparatus 20 is arranged such that two lighting devices 10 described in the present embodiment are juxtaposed to each other and light is emitted in a lower direction in (a) of FIG. 7 (see (a) of FIG. 7).

Note that according to the present embodiment, for example, the two lighting devices 10 are provided in each of which 4 columns of light sources 3 are provided in an x-axis direction at intervals of 17 mm and 20 columns of light sources 3 are provided in a y-axis direction at intervals of 21 mm so that the two lighting devices 10 are provided so as to be parallel to each other when seen from an x-z plane. The total number of light sources 3 is 80, and the light sources 3 have a total light source luminous flux of 10000 (1 m).

Note that the number of light sources 3 and a luminous flux are timely changed to be set in accordance with a size of a luminous flux required for the lighting apparatus 20.

The lighting apparatus 20 may be arranged not only such that the two lighting devices 10 are provided so as to be parallel to each other (see (a) of FIG. 7) but also such that the two lighting devices 10 are provided so as to have an angle Ψ (see (b) of FIG. 7). The angle Ψ is timely changed to be set in accordance with a design such as a housing, a cover, and the like (not illustrated) required for the lighting apparatus 20. Alternatively, also in order to efficiently widen, in a ±x-axis direction, light emitted from the lighting apparatus 20, the angle Ψ is timely changed to be set.

Next, the following description discusses a light distribution characteristic of the lighting apparatus 20. FIG. 8 shows a result of simulation of the light distribution characteristic of the lighting apparatus 20 of (a) of FIG. 7. FIG. 9 illustrates an evaluation condition in a case where the lighting apparatus 20 of (a) of FIG. 7 is used as a road light. (a) of FIG. 9 illustrates a state in which the lighting apparatus 20 is provided. (b) of FIG. 9 shows a relationship between the lighting apparatus 20 and each of observers 23a and 23b.

FIG. 8 assumes that a light source has a Lambert distribution as a light distribution characteristic. A solid line in FIG. 8 shows a light distribution characteristic in a plane shifted from the x-z plane by 16°. This corresponds to a light distribution characteristic obtained in a case where the lighting apparatus 20 is used for a road light and the lighting apparatus 20 is provided so as not to be parallel to a road 22 but so as to be inclined toward the road 22 by an angle η (see (a) of FIG. 9). The solid line corresponds to a light distribution characteristic in a plane including a center of the lighting apparatus 20 which is provided as illustrated in (a) of FIG. 9 and a center of a traffic lane which is closer to the lighting apparatus 20. Meanwhile, a broken line in FIG. 8 shows a light distribution characteristic in the y-z plane.

A conventional road light which includes no optical member 1 has a light distribution characteristic of having a peak in a direction of 0° as in the case of the light sources 3. However, according to the lighting apparatus 20, light can be widened by an effect of the prism groups 4 provided on the exit surface 1a of the optical member 1 (see FIG. 8). Therefore, according to the lighting apparatus 20, light distribution can have a peak in a vicinity of ±60°. Further, the prism groups 5 and the columnar convex lenses 6 each of which is provided on the entrance surface 1b of the optical member 1 allow light to be narrowed (an angle to be narrowed) in the y-z plane. This shows that the light distribution characteristic of the lighting apparatus 20 is narrowed.

In this simulation, a prism provided on the exit surface 1a is set to have a vertex angle φ1 of 55° and a base angle which decreases by 3° from θ1 of 77° to θ5 (see (b) of FIG. 2). Further, the prism is set to have a base width (base length) of 1 mm. A columnar lens having a curvature of 8 mm is used as a columnar convex lens 6 provided on the entrance surface 1b. A prism of a prism group 5 is set to have a base angle θ6 of 56° and a base angle θ7 of 64°, and a base width (base length) of 1 mm.

The following Table 1 shows a general brightness uniformity ratio and a traffic lane axis brightness uniformity ratio which are obtained in a case where the lighting apparatus 20 of the present embodiment is used for a road light.

TABLE 1

| | | Traffic lane axis |
|---|---|---|
| | General brightness | brightness |
| | uniformity ratio | uniformity ratio |
| Observer 23a | 0.51 | 0.6 |
| Observer 23b | 0.49 | 0.59 |

Note that a road reflectance published in European Standards is used to obtain the characteristic values shown in Table 1.

Note that according to the lighting apparatus 20, an x direction is parallel to a traffic direction of the road 22 (see (a) of FIG. 9). Note also that lighting apparatuses 20, each of which is connected to a lighting tool having a height of 8 m, are provided at intervals of 30 m (see (b) of FIG. 9). It is assumed that the road 22 has a total road width W of 9 m and has two opposite traffic lanes (4.5 m per traffic lane). In this case, assuming that η in (a) of FIG. 9 is 30°, a line defined by a center of the lighting apparatus 20 and a center of the traffic lane which is closer to the lighting tool (lighting apparatus 20) and a line defined by the center of the lighting tool and a center of the road 22 form an angle ξ of approximately 16°. The general uniformity ratio refers to a minimum brightness/a average brightness of the road 22 obtained in a case where the road 22 to be observed is seen from each of the observers 23a and 23b who are away from the road 22 by d of 60 m. The observers 23a and 23b are located at centers of the respective two opposite traffic lanes. In the case of the observer 23a, the traffic lane axis brightness uniformity ratio refers to a brightness uniformity on a line L1 seen from the observer 23a at the road to be observed. In the case of the observer 23b, the traffic lane axis brightness uniformity ratio refers to a brightness uniformity on a line L2 seen from the observer 23b at the road to be observed. The line L1 is away from the lighting apparatuses 20 by W/4, and the line L2 is away from the lighting apparatuses 20 by 3W/4. The general uniformity ratio and the traffic lane axis brightness uniformity ratio are required to have respective values of 0.4 or more and 0.5 or more. As shown in Table 1, it is revealed that the values in Table 1 meet their respective required values in a case where the lighting apparatus 20 is used for a road light.

As described earlier, each of the lighting device 10 and the lighting apparatus 20 of the present embodiment allows only the optical member 1 to control light distribution characteristics in respective two planes (the x-z plane and the y-z plane), so as to optimize the light distribution characteristics, the optical member 1 having (i) the entrance surface lb which is provided with the columnar convex lenses 6 and the prism groups 5 and (ii) the exit surface 1a which is provided with the prism groups 4a and 4b.

Further, according to the lighting device 10 and the lighting apparatus 20 of the present embodiment, it is unnecessary to use a housing or the like as a reflector. Therefore, a compact lighting device and a compact lighting apparatus can be made.

Also in a case where LED light sources which have a large light source area and are provided in an array are used as the light sources 3, it is possible to make the lighting device 10 and the lighting apparatus 20 each of which is excellent in light distribution characteristic without the fear of causing the lighting device 10 and the lighting apparatus 20 to be larger. This is because the columnar convex lenses 6 and the prism groups 4a, 4b, and 5 are provided so as to correspond to the respective LED light sources.

Note that each of the lighting device 10 and the lighting apparatus 20 of the present embodiment may be provided with, for example, a housing for fixing a power supply section and the light sources 3, and a cover. Assume that the lighting apparatus 20 is used outdoors, for example. In a case where the lighting apparatus 20 is provided with a housing and a cover, the light sources and the optical member 1 can be protected from, for example, rain and dust.

Each of the lighting device 10 and the lighting apparatus 20 using the lighting device 10 can be extensively used for outdoor lighting such as an outdoor security light, a street light, a road light, and a park light, and other lighting.

According to the lighting device 10, the optical member 1 has (i) the exit surface 1a which is provided with the prism groups 4a and (ii) the entrance surface 1b which is provided with the prism groups 5 and the columnar convex lenses 6. The prism groups 4a and 4b and the columnar convex lenses 6 are provided directly above the light sources 3 which are provided in an array. Each of the prism groups 5 is constituted by a plurality of prisms that are identical in shape and are provided at regular intervals, and a prism group 5 is provided between the respective light sources 3. The prism groups 5 and the columnar convex lenses 6 have a light collecting function. Meanwhile, the prism groups 4a and 4b provided on the exit surface 1a have a light diffusing function. Accordingly, light distributions in respective two directions which are orthogonal to each other can be separately controlled by causing the longer side direction of the prism groups 4a and 4b provided on the exit surface 1a and the longer side direction of the prism groups 5 and the columnar convex lenses 6 each of which is provided on the entrance surface 1 to be orthogonal to each other. That is, the prism groups 4a and 4b, the prism groups 5, and the columnar convex lenses 6 function as optical control elements controlling light distribution.

Each of the lighting device 10 and the lighting apparatus 20 allows one member (only the optical member 1) to control light distribution by use of such optical control elements. This (i) allows the lighting device 10 and the lighting apparatus 20 to be thinner and smaller and (ii) allows the lighting device 10 and the lighting apparatus 20 to be easy to assemble and highly efficient.

The lighting device of the present invention is preferably arranged such that: the entrance surface is provided with a plurality of lens sections; the plurality of lens sections are periodically provided in the longer side direction of the first prism group; and the plurality of lens sections narrow, in a direction in which the plurality of lens sections are periodically provided, an angle of distribution of light rays emitted from the plurality of light sources.

According to the arrangement, the plurality of lens sections are provided on the entrance surface of the optical member in the longer side direction of the first prism group. According to this, an angle of distribution of light rays having entered the plurality of lens sections from the plurality of light sources is narrowed in a direction in which the plurality of lens sections are periodically provided. Namely, the plurality of lens sections collect light emitted from the plurality of light sources. As a result, the plurality of lens sections can control light distribution differently from the first prism group. This allows the first prism group and the plurality of lens sections each of which is provided on the optical member to control light distribution characteristics in respective two axis directions, so that the light distribution characteristics can be optimized. Therefore, even in a case where no reflector or the like is used, it is possible to make a lighting device which has a light distribution and an illuminance that are suitable for, for example, a lighting apparatus for road illumination.

The lighting device of the present invention is preferably arranged such that: the plurality of lens sections include (i) respective columnar convex lenses and (ii) respective second prism groups each of which is constituted by a plurality of prisms; and the columnar convex lenses and the second prism groups are alternately provided.

According to the arrangement, the plurality of lens sections include (i) respective columnar convex lenses and (ii) respective second prism groups. According to this, a light ray having entered a columnar convex lens changes in optical path more inwardly in accordance with a curvature of the columnar convex lens than that having entered a planar surface. Meanwhile, a light ray having entered a second prism group dramatically changes in direction by being reflected in a prism plane. According to this, a larger amount of light can be extracted from the optical member, so that a light utilization efficiency can be enhanced. Further, the lighting device which efficiently illuminates a desired region can be made by a light collecting function of the columnar convex lenses and the second prism groups.

Distribution of light passing through the second prism groups and distribution of light passing through the columnar convex lenses can be controlled separately to some extent. This allows an illuminance distribution to be designed more freely and facilitates obtainment of a desired illuminance distribution.

In order to attain the object, a lighting apparatus of the present invention includes a lighting device mentioned above. Accordingly, it is possible to provide a lighting apparatus including a lighting device which has a simple arrangement and is capable of controlling a light distribution characteristic.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be extensively used for lighting devices such as an outdoor security light, a street light, a road light, and a park light each of which is used outdoors and for various lighting apparatuses including a lighting apparatus using a lighting device mentioned above.

### REFERENCE SIGNS LIST

1 Optical member
2 Substrate
3 Light source
4a, 4b Prism group (First prism group)
5 Prism group (Lens section, Second prism group)
6 Columnar convex lens (Lens section)
10 Lighting device
20 Lighting apparatus
22 Road
23a Observer
23b Observer

1. A lighting device comprising:
a plurality of light sources; and
an optical member having an entrance surface and an exit surface with respect to light emitted from the respective plurality of light sources,
the exit surface being provided with a first prism group which is constituted by a plurality of prisms, and
the first prism group widening, in a direction which is orthogonal to a longer side direction thereof, an angle of distribution of light rays emitted from the plurality of light sources.

2. The lighting device as set forth in claim 1, wherein:
the entrance surface is provided with a plurality of lens sections;
the plurality of lens sections are periodically provided in the longer side direction of the first prism group; and
the plurality of lens sections narrow, in a direction in which the plurality of lens sections are periodically provided, an angle of distribution of light rays emitted from the plurality of light sources.

3. The lighting device as set forth in claim 2, wherein:
the plurality of lens sections include (i) respective columnar convex lenses and (ii) respective second prism groups each of which is constituted by a plurality of prisms; and
the columnar convex lenses and the second prism groups are alternately provided.

4. The lighting device as set forth in claim 3, wherein the plurality of prisms constituting each of the second prism groups are provided at regular intervals and are identical in shape.

5. The lighting device as set forth in claim 3, wherein each of the plurality of prisms constituting each of the second prism groups has a prism plane whose angle is set so that light rays having reached the prism plane are totally reflected.

6. The lighting device as set forth in claim 1, wherein each of the plurality of prisms constituting the first prism group has a prism plane whose angle is set so that light rays having reached the prism plane are totally reflected.

7. The lighting device as set forth in claim 1, wherein:
the first prism group is constituted by the plurality of prisms which have respective triangular cross sections in a shorter side direction of the exit surface; and
the plurality of prisms are set to decrease in one of base angles as the plurality of prisms are closer to a central axis of the first prism group, the one of the base angles being farther from the central axis than the other of the base angles.

8. The lighting device as set forth in claim 7, wherein all the plurality of prisms constituting the first prism group are identical in vertex angle.

9. The lighting device as set forth in claim 1, wherein the plurality of light sources are LEDs.

10. A lighting apparatus comprising a lighting device recited in claim 1.
